(19) United States
(12) Patent Application Publication
(10) Pub. No.: US 2009/0076886 A1
(43) Pub. Date: Mar. 19, 2009

(54) ADVERTISEMENT PLUSBOX

(75) Inventors: Daniel Dulitz, Mountain View, CA (US); Alexandra Baugher, San Francisco, CA (US); David Marcin, Mountain View, CA (US); Radha Narayan, Sunnyvale, CA (US)

Correspondence Address: FISH & RICHARDSON P.C., PO BOX 1022, MINNEAPOLIS, MN, 55440-1022, US

(73) Assignee: Google Inc., Mountain View, CA (US)

(21) Appl. No.: 11/858,606

(22) Filed: Sep. 20, 2007

Related U.S. Application Data
(60) Provisional application No. 60/972,643, filed on Sep. 14, 2007.

(51) Int. Cl. G06Q 30/00; G06F 17/30; G06F 17/40

(52) U.S. Cl. 705/10; 705/14

(57) ABSTRACT

A first query including one or more keywords is received, and content associated with the one or more keywords is identified. A second query including the one or more keywords is received, and a product or service associated with the sponsored content is identified based on the one or more keywords. Information associated with the product/service is stored, and a selection is received from a display device indicating a request to display the information associated with the product/service. The information associated with the product/service is provided to the display device.

### CROSS-REFERENCE TO RELATED APPLICATION

This application claims priority to U.S. Provisional Patent Application Ser. No. 60/972,643 filed Sep. 14, 2007, and entitled “ADVERTISEMENT PLUSBOX,” the contents of which are incorporated herein by reference.

### BACKGROUND

This disclosure relates to information retrieval.

Content items, e.g., advertisements, can be identified by a search engine in response to a query by a user. The query can include one or more search terms, and the search engine can identify and rank the content items based on the search terms, e.g., keywords, in the query and on one or more parameters associated with the content item.

In some online advertising systems, the user/system that performed the query cannot determine whether the advertisements that are identified are actually relevant to the user's query. For example, the user may have performed the query to identify one or more products to purchase. While an identified advertisement may be identified, when the user clicks on the advertisement, the product in reality may be not associated with the advertisement.

### SUMMARY

Disclosed herein are systems, apparatus and methods for identifying products associated with sponsored content. In an implementation, a query including one or more keywords is received from a client device, and sponsored content associated with the one or more keywords is identified. A product or service associated with the sponsored content is identified based on the one or more keywords. Display data for displaying the sponsored content at the client device are generated and selection data for displaying information associated with the product or service proximate to the sponsored content at the client device are also generated. The display data and the selection data are provided to the client device.

In another implementation, a first query including one or more keywords is received, and sponsored content associated with the one or more keywords is identified. Display data for displaying the sponsored content are provided to a client device, and selection data for generating a product/service information element and for displaying product/service information proximate to the sponsored content are also provided to the client device. In response to receiving data indicating a selection of the product/service information element, a second query is issued including the one or more keywords, and a product or service associated with the sponsored content based on the one or more keywords is identified. Product/service information associated with the product or service is provided to the client device for displaying proximate to the sponsored content.

In another implementation, a first query including one or more keywords is received, and sponsored content associated with the one or more keywords is identified. A second query including the one or more keywords is received, and a product or service associated with the sponsored content is identified based on the one or more keywords. Information associated with the product or service is stored in a cache device, and a selection is received from a display device indicating a request to display the information associated with the product or service. The information associated with the product or service stored in the cache device is provided to the display device.

In another implementation, a first query including one or more keywords is issued, and sponsored content associated with the one or more keywords is received and displayed in response to issuing the query. A product/service information element is displayed proximate to the sponsored content, and in response to receiving a selection of the product/service information element, product/service information associated with the sponsored content is displayed in an enlargement area proximate to the sponsored content.

Identifying sponsored content that are relevant to a query and identifying products or services that are relevant to the sponsored content and/or query can advantageously result in an optimization of sponsored content revenue, e.g., advertising revenue. Additionally, such product identification can also enrich the user experience.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example online advertising system.

FIG. 2A is a block diagram of an example system that uses plusboxes to selectively display products corresponding to advertisements.

FIG. 2B is a block diagram of another example system that uses plusboxes to selectively display products corresponding to advertisements.

FIG. 3 is an example screen shot that includes plusboxes used to display products corresponding to advertisements.

FIG. 4 is a flow diagram of an example process for identifying sponsored content and products or services associated with the sponsored content in response to a query.

FIG. 5 is a flow diagram of an example process for identifying a product or service associated with the sponsored content based on the one or more keywords.

FIG. 6 is a flow diagram of an example process for identifying advertisements and products associated with the advertisements in response to a query.

FIG. 7 is a flow diagram of an example process for using first and second queries for identifying advertisements and associated products.

FIG. 8 is a flow diagram of an example process for displaying advertisements and a plusbox, and displaying product/service information if the user selects the plusbox.

FIG. 9 is a schematic diagram of an example computer system that can be utilized to implement the systems and methods described herein.

### DETAILED DESCRIPTION

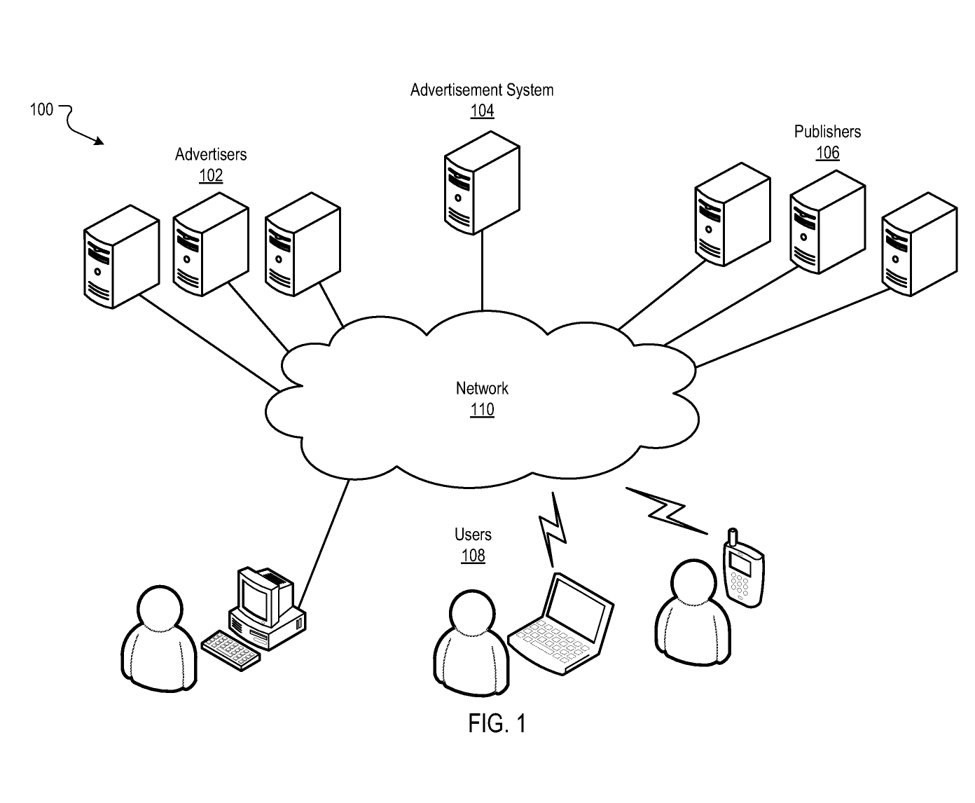

FIG. 1 is a block diagram of an example online content delivery (e.g., advertising) system 100. The system 100 provides sponsored content, in response to, for example, a query. By way of example, the sponsored content can be in the form of advertising or advertisements (“ads”). By way of example only, the system is described with reference to providing advertisements, though system 100 can provide other forms of sponsored content. A computer network 110, such as a local area network (LAN), wide area network (WAN), the Internet, or a combination thereof, connects the advertisers 102, an advertisement system 104, publishers 106, and users 108.

In some implementations, one or more advertisers 102 can directly, or indirectly, enter, maintain, and track advertisement (“ad”) information in an advertisement system 104. The advertisements may be in the form of graphical advertisements, such as banner advertisements, text only advertisements, image advertisements, audio advertisements, video advertisements, advertisements combining one of more of any of such components, etc. The advertisements may also include embedded information, such as links, meta-information, and/or machine executable instructions. One or more publishers 106 may submit requests for advertisements to the system 104. The system 104 responds by sending advertisements (e.g., when an associated publication is rendered) to the requesting publisher 106 for placement on one or more of the publisher's web properties (e.g., websites and other network-distributed content). As discussed above, while reference is made to advertisements, other content items can be provided by the system 104.

Other entities, such as users 108 and the advertisers 102, can provide usage information to the system 104, such as, for example, whether a click-through related to an advertisement has occurred, whether a conversion has occurred, or whether some other defined event has occurred. Such usage information can be processed to measure performance metrics, such as click-through rates, conversion rates, etc.

A click-through can occur, for example, when a user of a user device selects or “clicks” on an advertisement. The click-through rate can be a performance metric that is obtained by dividing the number of users that clicked on the advertisement or a link associated with the advertisement by the number of times the advertisement was delivered. For example, if an advertisement is delivered 100 times, and three persons clicked on the advertisement, then the click-through rate for that advertisement is 3%.

A “conversion” occurs when a user, for example, consummates a transaction related to a previously served advertisement. What constitutes a conversion may vary from case to case and can be determined in a variety of ways. For example, a conversion may occur when a user clicks on an advertisement, is referred to the advertiser's Web page and consummates a purchase there before leaving that Web page. Alternatively, a conversion may be defined as a user being shown an advertisement, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, dialing a telephone number, sending a product or service inquiry, etc. Other definitions of what constitutes a conversion are possible.

A conversion rate can be defined as the ratio of the number of conversions to the number of impressions of the advertisement (i.e., the number of times an advertisement is rendered) or the ratio of the number of conversions to the number of selections (or the number of some other earlier event). The type of conversion rate can be apparent from the context in which it is used. If a conversion is defined to be able to occur within a predetermined time since the serving of an advertisement, one possible definition of the conversion rate might only consider advertisements that have been served more than the predetermined time in the past.

Other usage information and/or performance metrics can also be used. The usage information and/or performance metrics can, for example, be revenue related or non-revenue related. In another implementation, the performance metrics can be parsed according to time, e.g., the performance of a particular content item may be determined to be very high on weekends, moderate on weekday evenings, but very low on weekday mornings and afternoons.

This usage information can include measured or observed user behavior related to advertisements that have been served. The system 104 performs financial transactions, such as crediting the publishers 106 and charging the advertisers 102 based on the usage information.

One example of a publisher 106 is a general content server that receives requests for content (e.g., articles, discussion threads, music, video, graphics, search results, web page listings, information feeds, etc.), and retrieves the requested content in response to the request. The content server may submit a request for advertisements to an advertisement server in the system 104, or embed code in the rendered page for the user 108 to execute and retrieve said ads. The advertisement request may include a number of advertisements desired. The advertisement request may also include content request information. This information can include the content itself (e.g., page or other content document), a pointer to the content by way of a uniform resource locator (“URL”), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, the content server (or a viewer (e.g., browser) associated with a content requester) can combine the requested content with one or more of the advertisements provided by the system 104. This combined content and advertisements can be sent/presented to the user 108 that requested the content. The content server can transmit information about the advertisements back to the advertisement server, including information describing how, when, and/or where the advertisements are to be rendered (e.g., in HTML or JavaScript™).

Another example publisher 106 is a search service. A search service can receive queries for search results. In response, the search service can retrieve relevant search results from an index of documents (e.g., from an index of web pages). An exemplary search service is described in the article S. Brin and L. Page, “The Anatomy of a Large-Scale Hypertextual Search Engine,” Seventh International World Wide Web Conference, Brisbane, Australia and in U.S. Pat. No. 6,285,999, both of which are incorporated herein by reference each in their entirety. Search results can include, for example, lists of web page titles, snippets of text extracted from those web pages, and hypertext links to those web pages, and may be grouped into a predetermined number of (e.g., ten) search results.

The search service can submit a request for advertisements to the system 104. The request may include a number of advertisements desired. This number may depend on the search results, the amount of screen or page space occupied by the search results, the size and shape of the advertisements, etc. In some implementations, the number of desired advertisements will be from one to ten, or from three to five. The request for advertisements may also include the query (as entered or parsed), information based on the query (such as geo-location information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. In some implementations, IR scores can be computed from, for example, dot products of feature vectors corresponding to a query and a document, page rank scores, and/or combinations of IR scores and page rank scores, etc.

The search service can combine the search results with one or more of the advertisements provided by the system 104. This combined information can then be forwarded to the user 108 that requested the content. The search results can be maintained as distinct from the advertisements, so as not to confuse the user between paid advertisements and presumably neutral search results.

Finally, the search service can transmit information about the advertisement and when, where, and/or how the advertisement was to be rendered back to the system 104.

As can be appreciated from the foregoing, the advertising system 104 can serve publishers 106 such as content servers and search services. The system 104 permits serving of advertisements targeted to content (e.g., documents) served by content servers or in response to search queries provided by users. For example, a network or inter-network may include an advertisement server serving targeted advertisements in response to requests from a search service with advertisement spots for sale. Suppose that the inter-network is the World Wide Web. The search service crawls much or all of the content. Some of this content will include advertisement spots (also referred to as “inventory”) available. More specifically, one or more content servers may include one or more documents. Documents may include web pages, email, content, embedded information (e.g., embedded media), meta-information and machine executable instructions, and advertisement spots available. The advertisements inserted into advertisement spots in a document can vary each time the document is served or, alternatively, can have a static association with a given document.

In one implementation, the advertisement system 104 may serve advertisements that include product/service information. For example, the advertisements may be associated with one or more related products. In one implementation, the product associations may be based on the same types of keywords used for locating advertisements. In some implementations, other types of associations may be used, such as product categorization. In other implementations, the association between a product and an advertisement may depend on relevancy measures, such as targeted keywords, product descriptions, customer or user profile information, etc.

Products associated with an advertisement may be automatically displayed to the user 108 when the associated advertisement is displayed. In some implementations, the user 108 may use an interaction mechanism to control when such products are displayed. Such an interaction mechanism can be realized, for example, by selection data that is operable to display products associated with the advertisement in an enlargement area, e.g., a user interface element that can expand or contract, proximate to the advertisement. In this way, the user 108 may view a particular advertisement (e.g., an advertisement in the form of a creative for an online florist, in which the creative includes text, graphics, audio and/or video associated with the florist) and decide whether or not to display the associated products, such as specific floral arrangements that the user 108 may order.

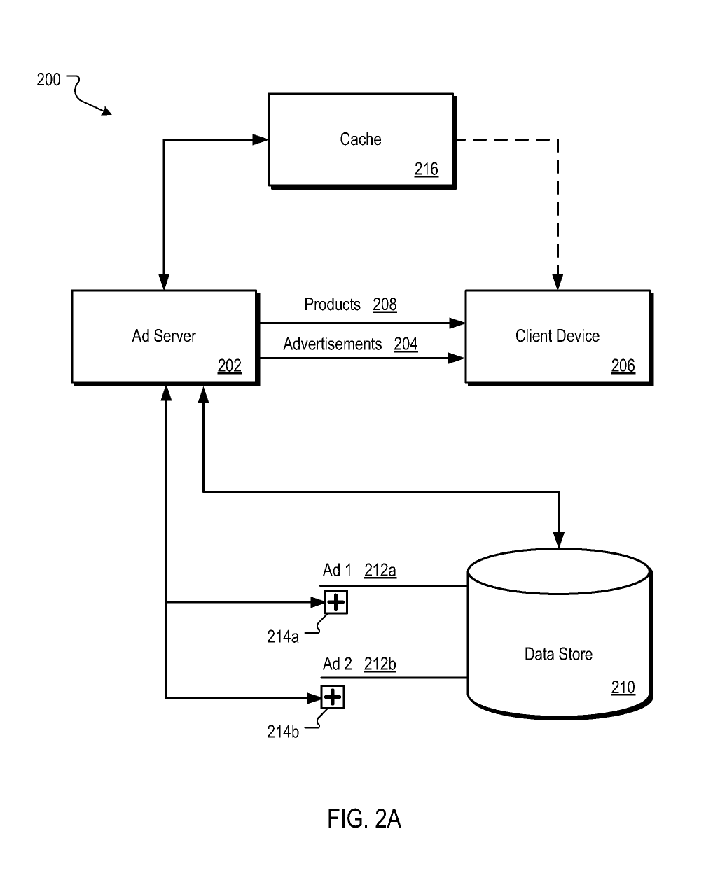

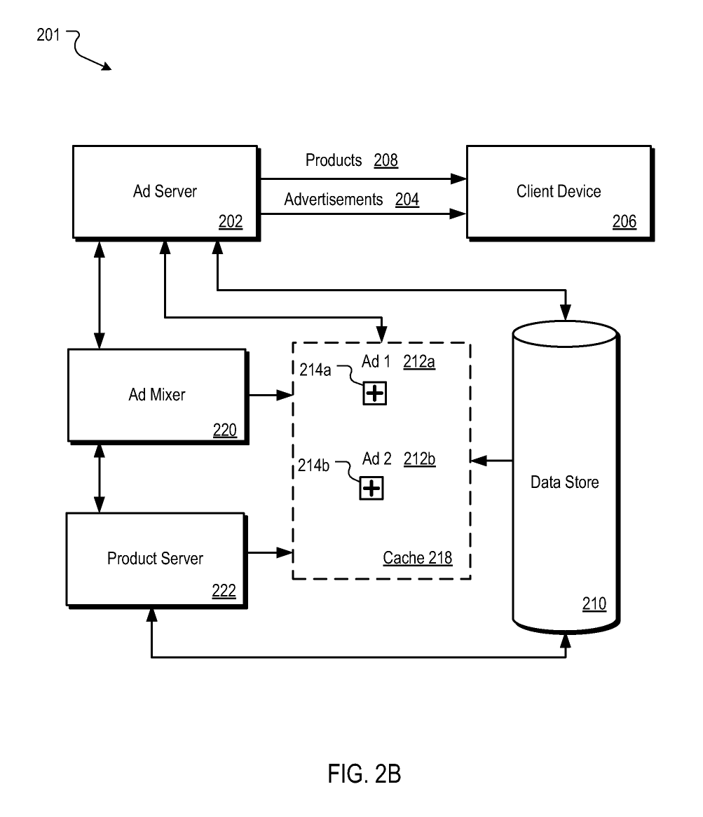

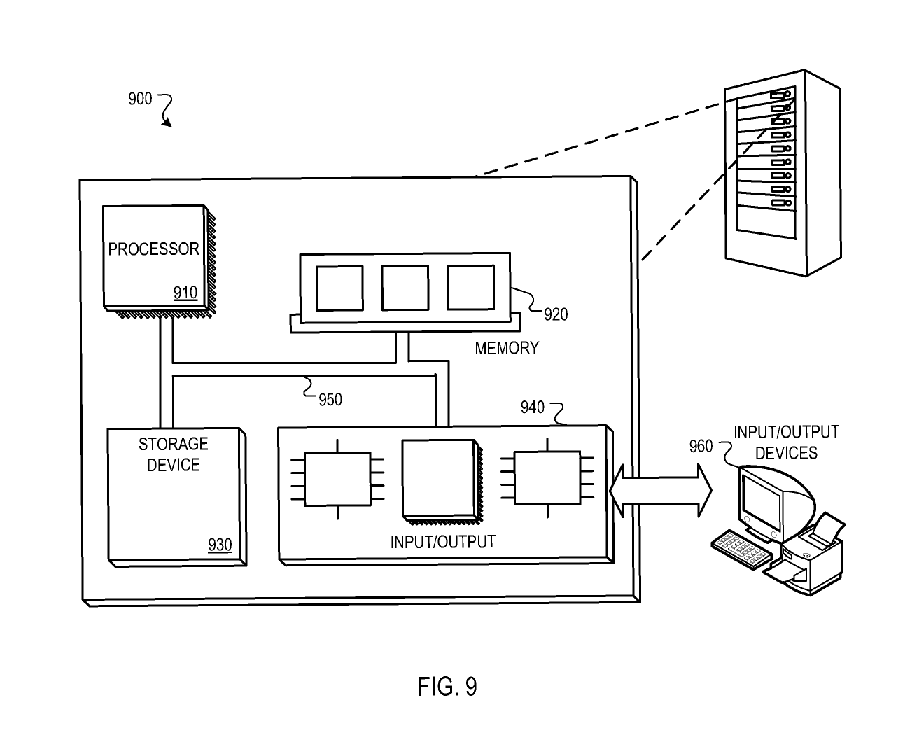

FIG. 2A is a block diagram of an example system 200 that uses product information elements, e.g., plusboxes, to selectively display products corresponding to advertisements. The system 200 can, for example, be implemented in the advertisement system 104 utilizing one or more computing devices that include memory devices storing processing instructions and processing devices for executing the processing instructions. An example computing system is shown and described with reference to FIG. 9. Other implementations, however, can also be used.

The system 200 can display an advertiser's product information in a way that provides the user with a level of control and interaction for displaying the advertiser's products. For example, when a user receives search results in response to an online search, such as a query entered in a web browser networked with the Internet, the search results can include advertisements. The advertisements can also be associated with any products that the search engine determines are relevant to the user's query. In some implementations, instead of displaying the products within the advertisement, the user is presented with a “plusbox” within or proximate to (e.g., in time or space) the advertisement. If the user selects (e.g., clicks on) the plusbox, the user can see the relevant products for the corresponding advertisement.

In some implementations, the system 200 can allow an advertiser to specify product information related to products that may be displayed with that advertiser's advertisements. When the advertisements are displayed, if there is product information associated with the advertisements that are determined to be relevant to the user's query, a plusbox can be displayed. The initial display of the plusbox can occupy one additional line in a creative. When the user clicks on the plusbox, the system 200 can return the product information that match the user's original query. The display can show summary information about each product, along with a link to the advertiser's landing page for each product. In some implementations, the displaying of product information from a plusbox can be monetized. For example, clicks on the product links can be counted as advertisement clicks. Opening or closing the plusbox may also be counted as an advertisement click, or, alternatively, can be free to the advertiser.

In one implementation, the plusbox feature can be displayed only when products are identified that are relevant to the user's specific query. For example, suppose an advertiser has products that are mp3 players, but the advertiser has no products that are ferret hammocks. If the advertiser has specified product information directed to mp3 players, but the associated campaign contains keywords targeting for mp3 players and for ferret hammocks (e.g., “Buy $keyword on eBay”), the system 200 can determine from the user query that information about ferret hammock products should not be shown to a user looking for mp3 players. Accordingly, the system 200 will not generate selection data that displays a plusbox link implying that there are products related to ferret hammocks. In this way, the plusbox is shown only when products that are of interest to the user are identified, and thus may provide the user with highly-relevant information about the advertiser's product offerings related to their query.

In one implementation, the information in the plusbox can be related. For example, if the product is apples, the information in the plusbox may not be information associated with apples, but rather information on a related product, such as other fruit, e.g., bananas.

In one implementation, an advertiser 102 who wants to opt in to using the plusbox feature may, for example, upload product information related to products to the advertising system 104 using existing mechanisms for file upload. For example, if the advertiser 102 already uses the advertising system 104 and wants to include only a subset of the offers (e.g., owned by his customer ID), the advertiser 102 may tag the offers eligible for the plusbox feature using a special attribute. These offers may conform to a predetermined schema for product offers, such as requiring that products include some or all of: a product image, a product page URL, product title, a description, a price, a brand identification, and a categorization.

In one implementation, the advertiser 102 can then specify which campaigns should have the plusbox feature enabled and link those campaigns with the desired set of offers from advertising system 104. This metadata can be stored in an advertisements database. The advertiser specifies the customer ID (e.g., Google Base Customer ID) used in the upload. The advertiser may also specify the special attribute mentioned above, which will be included in queries issued for plusbox expansion for advertisements in this campaign. This allows the advertiser to have multiple campaigns that include overlapping sets of offers.

Other processes to associate product with advertisements can also be used. For example, if an advertiser has products and advertisements associated with keywords, the advertisements and the products that are identified in response to a query can be shown. For example, a sporting equipment company may have the keywords “football,” “baseball,” and “golf” associated with an advertisement, and a number of products respectively associated these keywords and other keywords. If the advertisement, e.g., “Buy your sporting gear here” is shown in response to the query “golf shoes,” then a plusbox may be displayed to show golf shoe products sold by the advertiser.

In one implementation, the system 200 can include an ad server 202 that serves advertisements 204 to a client device 206. The ad server 202 can serve advertisements provided by the advertisers 102 as part of, or in coordination with, the advertisement system 104. The advertisements may be served over the network 110 and viewed by a user 108 on a client device 206, such as a laptop, home computer, PDA, cell phone, set top box, game console, portable electronic device, etc.

In one implementation, the ad server 202 can serve products 208 to the client device 206. The products 208 may correspond to the advertisements 204 identified by the ad server 202 in response to a query. For example, while the advertisements 204 may be advertisements for flowers offered by one or more online florists, the products 208 associated with the advertisements 204 may be individual floral arrangements that a customer can purchase online.

The advertisements 204 may be stored in a data store 210. For example, the data store 210 can store information for advertisements that the ad server 202 can serve, such as an ad1 212a and an ad2 212b. When the user 108 requests advertisements or issues a search query that results in the identification of advertisements, such as the ad1 212a and/or the ad2 212b, the ad server 202 can provide the advertisements 212a and 212b as advertisements 204. For example, the ad1 212a may be an advertisement for a local florist that advertises online, and the ad2 212b may be an advertisement for a nationwide florist that advertises online. The advertisements 212a and 212b can be displayed on the client device 206 as the result of a search for online florists (e.g., using a search query “flowers”) entered in the user's browser.

In some implementations, the data store 210 may store information that associates products with advertisements. The information may include keyword indexes, product categorization tables, rules for selecting products based on user profiles, and the like.

The ad server 202 can generate selection data, e.g., data that when rendered on a client device displays one or more plusboxes 214a and 214b corresponding to the ad1 212a and the ad2 212b, respectively. In some implementations, the plusboxes 214a and 214b are rendered beneath each of the advertisements 212a and 212b, and as such facilitate the viewing of products corresponding to displayed advertisements, such as displaying individual floral arrangements for a flower advertisement displayed in the user's browser. For example, the user viewing advertisements on the client device 206 may select the plusbox 214a to display the corresponding products. As a result of selecting such a plusbox, the ad server 202 can serve the products 208 to the client device 206. Similarly, if the user wants to see the products associated with the ad2 212b, the user can select the plusbox 214b.

In some implementations, user selection of plusboxes (e.g., the plusbox 214b) can be used to update click-through rates. For example, when a user selects a plusbox, the number of clicks for the associated advertisement may be incremented, thereby increasing the click-through rate associated with the advertisement. In some implementations, individual click-through rates may be maintained in order to track the popularity of individual products. Alternatively, the interactions with the plusboxes can be separately tracked.

In some implementations, when a user orders or buys an individual product displayed in an area associated with the plusbox, a conversion can be deemed to have occurred. For example, such a conversion (e.g., indicating the consummation of a transaction) may be similar to conversions corresponding to advertisements and products that are displayed without the plusbox feature.

The system 200 of FIG. 2A can facilitate the provisioning of advertisements and related product information in a variety of ways. For example, a client device 206 can send a query including one or more keywords to ad server 202. The ad server 202 can use the keywords to find an advertisement from a data store 210. The ad server 202 can determine whether a product is available from the data store using the advertisement and the keywords. The ad server 202 can then send the advertisement and information associated with the product, if a product is available, to the client device 206. The client device 206 can display the advertisement and, if a product is available, a product selector associated with the product to display the information associated with the product.

In one implementation, the information for the products 208 can be cached in a cache 216. For example, while the ad server 202 provides advertisements 204 to the client device 206, the ad server 202 can begin caching the information for the corresponding products 208 to the cache 216. The caching can occur in the same order that the advertisements 204 are processed, such as in the order that the ad server 202 provides the advertisements 204 to the client device 206 for display in the user's browser. For example, caching of products corresponding to the user's initial search results can occur also immediately, while caching for lower-ranked advertisements may wait until the user scrolls to that portion of the search results.

During caching, the ad server 202 can compute and cache information about products associated with these advertisements. The ad server 202 may query the data store 210 as needed, and cache the results so that the ad server 202 can quickly determine whether any given advertisement impression should include a corresponding plusbox for display.

In one implementation, the system 200 may eliminate the caching step that pre-caches an advertiser's products. For example, the system 200 may wait to identify the products 208 until after the user selects the plusbox 214a or 214b. Selection of a plusbox can cause the client device 206 to generate data indicating such a selection. The ad server 202 can receive the data, and in response, issue another query that includes the keywords of the original query to identify the products.

For example, the ad server 202 can operate as a two-query server. The first query can, for example, be for advertisements 204 related to keywords, such as one or more query terms that the user 108 may enter in a browser on the client device 206. For example, the query may include the search term “flowers” that the user enters to find online florists. As a result of the first query, the ad server 202 can identify flower-related advertisements 204 responsive to the first query in the data store 210. The advertisements can be displayed to the user on the client device 206. The second query can, for example, be product/service-related. For example, the user may decide to view the products associated with an advertisement, such as by selecting the plusbox 214a. As a result, the ad server 202 can perform the second query to identify products associated with the advertisement and serve the products 208 to the client device 206. If the products 208 are already cached in the cache 216, the products 208 can be provided to the client device 206 from the cache 216. While reference is made to products being served, information relating to products or services can be served.

FIG. 2B is a block diagram of another example system 201 that uses plusboxes to selectively display products corresponding to advertisements. The system 201 is similar to the system 200 of FIG. 2A, except that the system 201 includes a separate ad server 202, an optional cache 218, an ad mixer 220, and a product server 222. The ad server 202, ad mixer 220, and the product server 222 can define an advertisement engine that identifies and serves advertisements and identifies and serves product information related to the identified advertisement.

In one implementation, the system 201 can determine whether to show the plusboxes 214a for Ad1 212a and 214b for Ad2 212b before the advertisements Ad1 212a and Ad2 212b are returned to the client device 206. Therefore, the advertisements can be selected, and a determination is made as to whether to display the plusboxes prior to returning the advertisements to the client device 206.

In one implementation, the ad server 202 can query the data store 210 to determine whether any advertisements are associated with one or more keywords in a query. The product server 222 can compute and cache information about products associated with these advertisements in the cache 218. The ad mixer 220 can then determine whether a plusbox should be associated with each advertisement selected by the ad server 202. The ad mixer 220 can, for example, determine whether to show the plusboxes 214a and 214b for each advertisement Ad1 212a and Ad2 212b. The ad mixer 220 can send a request to the product server 222, where the request includes the advertisements identified by the ad server 202 to determine whether products are associated with each advertisement. If the ad mixer 220 receives an affirmative response from the product server 222, the ad mixer 220 can provide data that causes the client device 206 to display the plusbox associated with each advertisement.

In one implementation, the product server 222 can respond to requests from the ad mixer 220 to determine whether a plusbox should be displayed at the client device 206 for a particular advertisement. In another implementation, the product server 222 can provide product information to the client device 206 to include in the plusbox associated with the advertisement. Upon receiving a request for product information, the product server 222 can first determine whether the product information is stored in the cache 218, and if the product information is not stored in the cache 218, then the product server 222 can query the data store 210 to determine if any products match a user's query. In some implementations, the cache 218 can be omitted. Therefore, upon receiving a request for product information, the product server can query the data store 210 to determine if any products match the user's query.

The system 200 of FIG. 2B can facilitate the provisioning of advertisements and related product information in a variety of ways. For example, the client device 206 can send query and an advertisement to the product server 222. The product server 222 can use the query and the advertisement and find product information in the data store 21. The product server 222 can send the product information to the client device 206, and the client device 206 can display the product information.

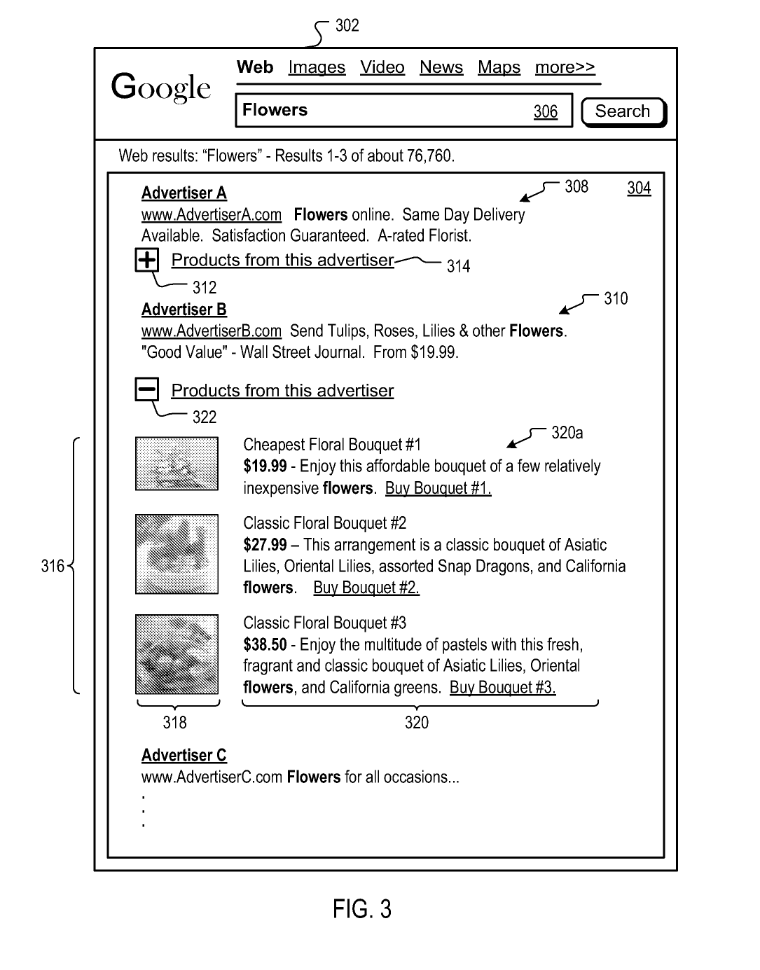

FIG. 3 is an example screen shot 302 that includes plusboxes used to display products corresponding to advertisements. For example, the screen shot 302 may be displayed in a user's browser on a client device 206, such as a smart phone, a personal computer, a personal digital assistant (PDA), or some other wired or wireless electronic device. The screen shot 302 includes a search results area 304 that can display search results. For example, the search results displayed in the search results area 304 may be in response to a specific search query, such as a “Flowers” search term 306 that the user may enter in a browser to locate online florists. In response to the search term 306, the system can display advertisements matching the query. For example, the system can display advertisements for an advertiser A 308 and an advertiser B 310. Such advertisements can include search terms from the search term 306, and may further highlight (e.g., by bolding, highlighting or the like) individual terms from the search query. As depicted, the search term “Flowers” is highlighted with bolding in the advertisements for the advertiser A 308 and the advertiser B 310.

Initially, when advertisements are displayed in the search results area 304, they may be displayed in a way similar to that depicted in the advertisement for advertiser A 308. As such, the advertisement may contain the name of the advertiser (e.g., “Advertiser A”), one or more links to individual landing pages associated with the advertiser (e.g., home page “www.AdvertiserA.com”), a summary of the goods and/or services offers by the advertiser, and one or more controls that the user may select to view products corresponding to the advertisement. As depicted in the advertisement for advertiser A 308, product information elements include a plusbox 312, a minus box 322, and an action prompt 314. If the user is interested in viewing product corresponding to the advertiser A 308, the user may respond to the action prompt 314 by selecting the action prompt 314 to display the corresponding products. In some implementations, selecting the plusbox 312 may be an alternative way for the user to display product information.

The advertisement for the advertiser B 310 depicts an example display that may result from the user selecting a plusbox, such as the plusbox 312. Specifically, the advertisement for the advertiser B 310 includes an enlargement area 316, e.g., a product information area 316. Each of the products included in the product information area 316 can include one or more images 318 and a summary 320 of the product. The product's summary 320 can include the product price, a brief product description, and other information or controls that the user may employ to obtain additional product information or buy the product. In some implementations, buying a product may be accomplished by adding the product to an online shopping cart for later checkout and payment. Additional controls may exist for controlling the visual presentation of the product, or to control any audio component of the product's presentation, or other such features.

In some implementations, the product price may automatically display in the currency defined for the user, such as in a settings control associated with the user's browser. In some implementations, multi-currency or other such controls may exist for automatically converting a price in one currency (e.g., US Dollars) to a different currency (e.g., Euros).

The minusbox 322 is included in the advertisement for the advertiser B 310. The minusbox 322 display may replace a plusbox display (e.g., the plusbox 312) when the plusbox is selected and the products corresponding to the advertisement are displayed. The user may select a minusbox to hide (or un-display) the product information currently displayed. For example, a user viewing the product information in the product information area 316 may hide the information by selecting the minusbox 322. Thus the selection of such product information elements can expand and collapse the enlargement area 316.

In some implementations, other user interfaces or other elements may be used in addition to (or as an alternative to) the plusbox. For example, the user interface may include the use of a button or other control that the user can select to display specific products for an advertiser. In another example, the user may simply “hover” over the advertiser's name (or corresponding entry on the screen) or advertisement to display specific products. For instance, the user may drag the mouse over the advertiser's name or a specific area in the displayed entry. Accordingly, the creative text of the advertiser's name can include an embedded selection data.

In some implementations, the user may be able to supply additional inputs to filter advertisements that are displayed after selecting a plusbox. For example, controls may allow the user to list the products in order by most expensive first, least expensive first, or other criteria. Such criteria may exist, for example, in a user-configurable set of web browser settings.

The number of products that are included with an advertisement may depend on various factors. For instance, the ad server may only provide products that meet a certain quality threshold. The threshold may depend, for example, on the number or percentage of keywords for the particular product's description that match the search terms in the user's original query. For example, “best-matched” products may be those having descriptions containing keywords matching all or most of the terms in the user's search query.

The number of “best-matched” products may be used with other limiting numbers. For example, the number of products may be limited to a number that, when displayed, does not significantly reduce the amount of non-ad information displayed on the user's screen. Such a display limitation may depend on the device from which the search query is submitted. For example, while a user's home computer or laptop may have a large display area capable of displaying ten products, a hand-held device (e.g., smartphone, PDA, etc.) may have sufficient screen space for two to five products. In some implementations, the area on the screen that displays the products may include a scroll bar or other control for displaying a few products at a time.

In another example of limiting the number of products served to the user, an arbitrary limit may be established so as not to overwhelm the user with too many products. For example, the number of products may be limited to a manageable number (e.g., ten or less). In some implementations, the arbitrary number may be increased or decreased depending on the user's age and/or perceived ability to visually process a number of products.

In one implementation, the products returned for an advertisement may be ranked. For example, the ranking can be affected by the number or percentage of keywords in a product's description that match the search terms in the user's original query. The word matching may rely on processes that match different variations of words, so that, for example, a search term containing “rose” will match a “roses” keyword in a product description. Such matching may rely on fuzzy logic, grammar rules, or other processes.

In one implementation, ranking of products may also depend on information in the user's profile. For example, if the user's profile includes information indicating that the user is a car enthusiast, the ranking system may rank a car-shaped flower vase higher than a vase shaped like a panda. As such, the user may see the car-shaped flower vase listed first in the list of products, and the panda-shaped vase further down in the list. Profile-based ranking may also use other information such as the user's gender, age, income, occupation, geographic location and interests.

In one implementation, ranking of products may also be price-based. For example, higher-priced products may be ranked higher for wealthy professionals as compared to teenagers or college students (e.g., as determined from user profile information).

In another implementation, prices of products may be used to rank products (e.g., having a higher price) higher than accessories (e.g., having a lower price). Ranking products higher than accessories may occur, for example, when the system determines from the user's query terms that products (and not accessories) are the likely target of the user.

In another implementation, products may be ranked from information derived from a brand name. For example, certain brand names may target certain price ranges for products, e.g., computers of Brand X may be in the $400-$800 dollar range; Brand Y, $700-$1,200; and Brand Z, $1,100-$3,000. Accordingly, a search query of “X Y Computers” may identify an advertisement for a computer store that sells multiple brands of computers. Thus computers in the price range of $400-$1,200 may be identified as related products, regardless of brand, and those of brand X and Y, if any, may be ranked highest.

Other ranking schemes can be used to rank products, such as ranking products that are determined more interesting to the user; products that are on sale for a short time; products that have a higher profit ratio for the advertiser; or other such ranking orders or weighted combinations thereof.

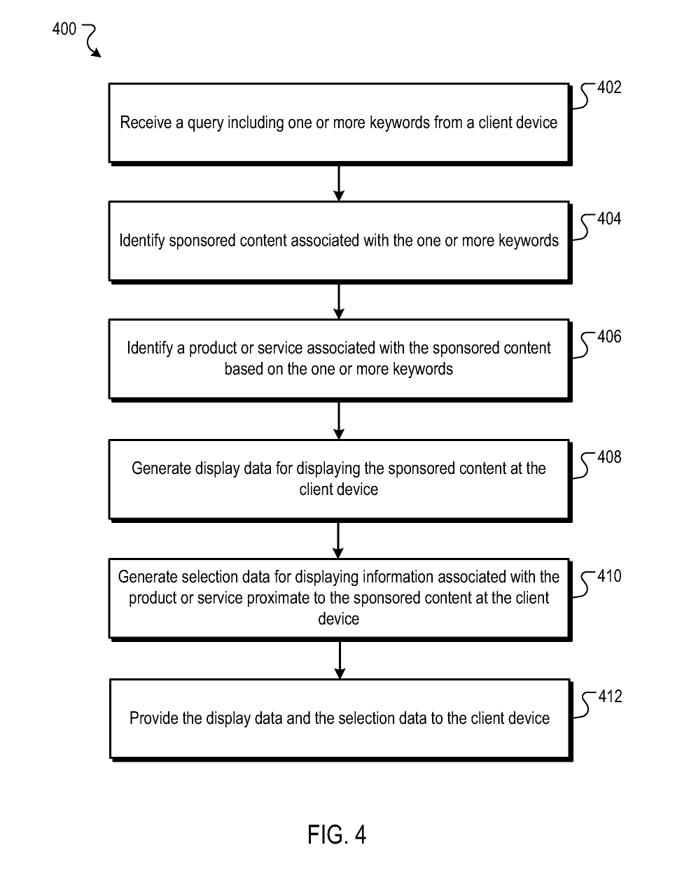

FIG. 4 is a flow diagram of an example process for identifying sponsored content and products or services associated with the sponsored content in response to a query. The process 400 can, for example, be implemented in a system such as the system 200 of FIG. 2. The process 400 may, for example, occur on the server side of client-server implementation of the system 200.

Stage 402 receives a query including one or more keywords from a client device. For example, referring to FIG. 3, the query may be a search query, such as “Flowers,” that the user enters on a browser on the client device 206 and which is transmitted over a network to the ad server 202. The query may be entered, for example, to find online florists.

Stage 404 identifies sponsored content associated with the one or more keywords. For example, the ad server 202 may identify an advertisement for advertiser A 308. Specifically, identification of the advertisement for advertiser A 308 may occur because the keyword “flowers” is in the advertisement.

Stage 406 identifies a product or service associated with the sponsored content based on the one or more keywords. For example, the ad server 202 can identify products or services for display in the product information area 316. Such products or services may be categorized, for example, so that they are known to be related to florists or flowers.

Stage 408 generates display data for displaying the sponsored content at the client device. For example, the ad server 202 may generate display data that can be provided to the client device 206 and causes the advertisement for Advertiser A 308 to be displayed in the search results area 304.

Stage 410 generates selection data for displaying information associated with the product or service proximate to the sponsored content at the client device. For example, the ad server 202 can generate the selection data that causes the plusbox 312 to be rendered beneath the advertisement for Advertiser A 308 on the client device 206, and/or renders the action prompt 314, such as “Products from this advertiser.”

Stage 412 provides the display data and the selection data to the client device. For example, the ad server 202 can transmit the display data and the selection data to the client device 206 for rendering on a display device.

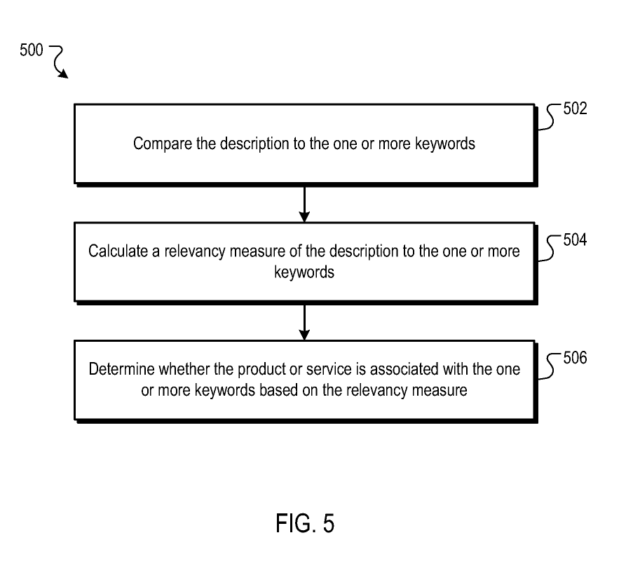

FIG. 5 is a flow diagram of an example process 500 for identifying a product or service associated with the sponsored content based on the one or more keywords. For example, the identification may be associated with stage 404 of the process 400. The process 500 may, for example, occur on the server side of client-server implementation of the system 200.

Stage 502 compares a product or service description to the one or more keywords. For example, the keyword such as “flowers” in the product description for the product summary 320a can be compared to the keywords associated with the advertisement for Advertiser A 308. The keywords in this comparison can correspond to the terms of the search query that the user may enter, for example, to find online florists.

Stage 504 calculates a relevancy measure of the description to the one or more keywords. For example, the relevancy measure may use a count of the number of keyword matches between a product description and the advertisement.

Stage 506 determines whether the product or service is associated with the one or more keywords based on the relevancy measure. For example, if a product description matches most or all of the keywords corresponding with the advertisement, the product can be considered to be associated with the advertisement.

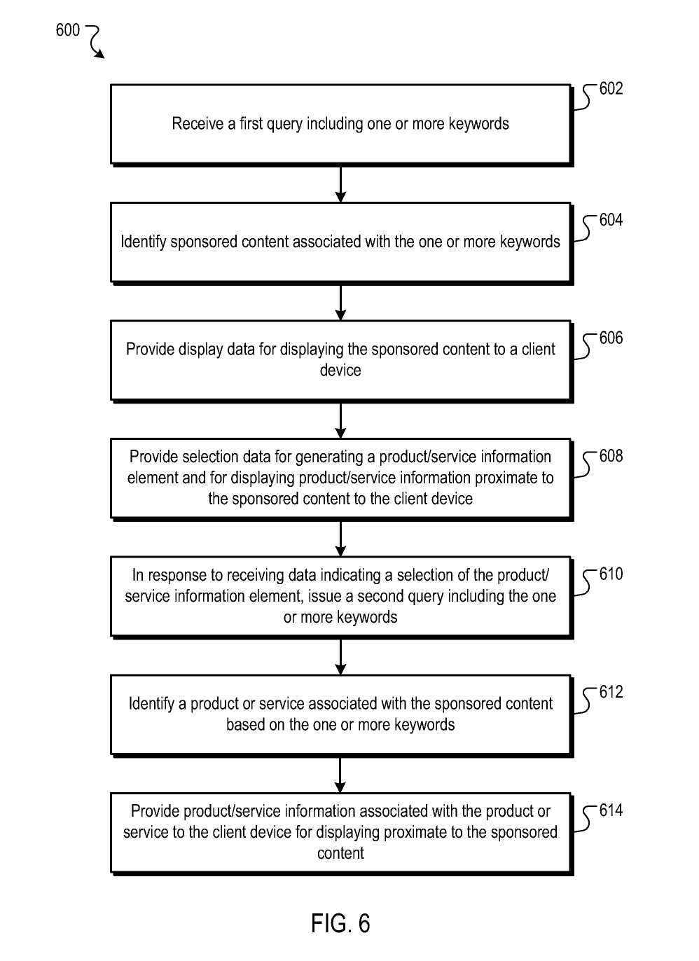

FIG. 6 is a flow diagram of an example process 600 for identifying sponsored content and products or services associated with the sponsored content in response to a query. The process 600 may, for example, occur on the server side of client-server implementation of the system 200.

Stage 602 receives a first query including one or more keywords. For example, the first query may be a search query, such as “Flowers,” that the user enters on a browser on the client device 206. The first query may be entered, for example, to find online florists.

Stage 604 identifies sponsored content associated with the one or more keywords. For example, the ad server 202 may identify the advertisement for advertiser A 308. Specifically, identification of the associated advertisement for advertiser A 308 may occur because the keyword “flowers” is in the advertisement.

Stage 606 provides display data for displaying the sponsored content to a client device. For example, the ad server 202 may generate the data that causes the advertisement for Advertiser A 308 to be displayed in the search results area 304 on the client device 206

Stage 608 provides selection data for generating a product/service information element and for displaying product/service information proximate to the sponsored content to the client device. For example, the ad server 202 can generate selection data that causes the plusbox 312 to be rendered beneath the advertisement for Advertiser A 308 on the client device 206, and/or renders the action prompt 314, such as “Products from this advertiser.”

Stage 610, in response to receiving data indicating a selection of the product/service information element, issues a second query including the one or more keywords. For example, if the user selects (e.g., clicks on) the action prompt 314 or the plusbox 312, the client device 206 can send data indicating such selection to the ad server 202. The ad server 202, in turn can issue and process the second query. Specifically, the second query, using the keyword “Flowers,” can be targeted to identify the floral products associated with the advertisement for advertiser A 308.

Stage 612 identifies a product or service associated with the sponsored content based on the one or more keywords. For example, the ad server 202 can identify the one or more specific floral products associated with the advertisement for advertiser A 308.

Stage 614 provides product/service information associated with the product or service to the client device for displaying proximate to the sponsored content. For example, the ad server 202 can provide the product/service information for the three different floral products to the client device 206, which can, in turn, be displayed in the product/service information area 316.

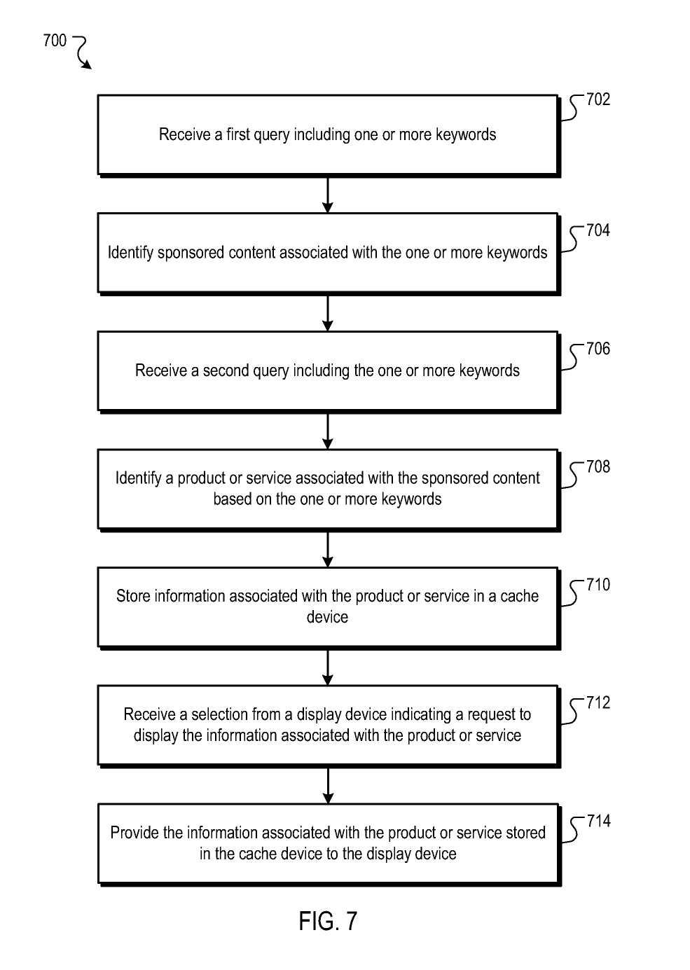

FIG. 7 is a flow diagram of an example process 700 for using first and second queries for identifying advertisements and associated products. The process 700 may, for example, occur on the server side of client-server implementation of the system 200.

Stage 702 receives a first query including one or more keywords. For example the first query received may be a search query, such as “Flowers,” that the user enters on a browser on the client device 206.

Stage 704 identifies an advertisement associated with the one or more keywords. For example, the ad server 202 may identify the advertisement for advertiser A 308. Specifically, identification of the associated advertisement for advertiser A 308 may occur because the keyword “flowers” is in the advertisement.

Stage 706 receives a second query including the one or more keywords. For example, the ad server 202 can receive a second query, such as a query that uses the keyword “Flowers,” that may be targeted to identify the floral products associated with the advertisement for advertiser A 308.

Stage 708 identifies a product associated with the advertisement based on the one or more keywords. For example, the ad server 202 can identify the one or more specific floral products associated with the advertisement for advertiser A 308.

Stage 710 stores information associated with the product in a cache device. For example, the ad server 202 may store the product/service information for the associated products in the cache 216.

Stage 712 receives a selection from a display device indicating a request to display the information associated with the product or service. For example the ad server 202 may receive a request from the client device 206 to display product/service information. Specifically, the product/service information may correspond to the products associated with ad1 212a.

Stage 714 provides the information associated with the product or service stored in the cache device to the display device. For example the ad server 202 may provide the product/service information for the products 208 to the client device 206.

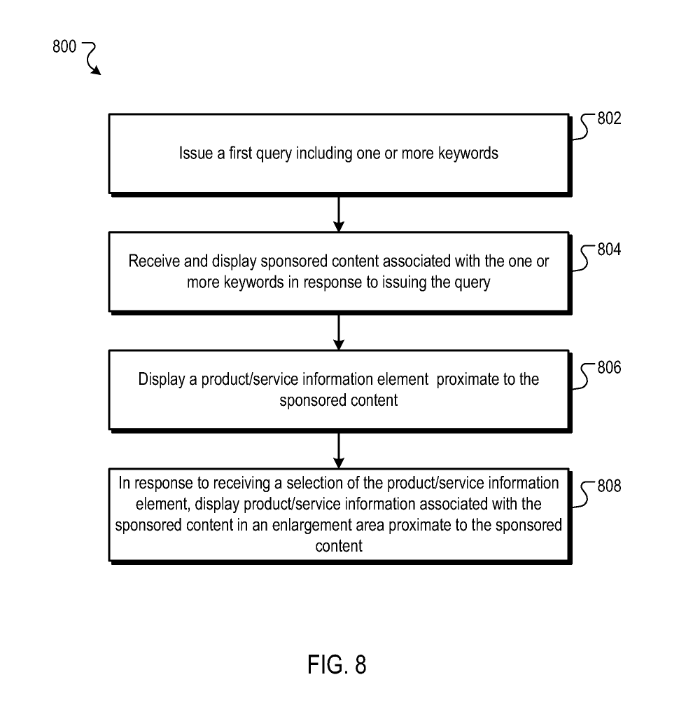

FIG. 8 is a flow diagram of an example process 800 for displaying advertisements and a plusbox, and displaying product/service information if the user selects the plusbox. Such a process may, for example, occur on the client side of client-server implementation of the system 200.

Stage 802 issues a first query including one or more keywords. For example, referring to FIG. 3, the first query issued may be a search query, such as “Flowers,” that the user enters on a browser on the client device 206.

Stage 804 receives and displays sponsored content associated with the one or more keywords in response to issuing the query. For example, the client device 206 may receive and display the advertisement for advertiser A 308. Specifically, identification of the associated advertisement for advertiser A 308 may occur because the keyword “flowers” is in the advertisement.

Stage 806 displays a product/service information element proximate to the sponsored content. For example, the client device 206 can display the plusbox 312 beneath the advertisement for Advertiser A 308. The client device 206 can also display the action prompt 314, such as “Products from this advertiser.”

Stage 808, in response to receiving a selection of the product/service information element, displays product/service information associated with the sponsored content in an enlargement area proximate to the advertisement. For example, in response to the user selection of the action prompt 314 (or the plusbox 312), the client device 206 can display the floral products associated with the advertisement for advertiser A 308. The display can, for example, be placed beneath or adjacent to the action prompt 314 (or the plusbox 312).

FIG. 9 is block diagram of an example computer system 900. The system 900 includes a processor 910, a memory 920, a storage device 930, and an input/output device 940. Each of the components 910, 920, 930, and 940 can, for example, be interconnected using a system bus 950. The processor 910 is capable of processing instructions for execution within the system 900. In one implementation, the processor 910 is a single-threaded processor. In another implementation, the processor 910 is a multi-threaded processor. The processor 910 is capable of processing instructions stored in the memory 920 or on the storage device 930.

The memory 920 stores information within the system 900. In one implementation, the memory 920 is a computer-readable medium. In one implementation, the memory 920 is a volatile memory unit. In another implementation, the memory 920 is a non-volatile memory unit.

The storage device 930 is capable of providing mass storage for the system 900. In one implementation, the storage device 930 is a computer-readable medium. In various different implementations, the storage device 930 can, for example, include a hard disk device, an optical disk device, or some other large capacity storage device.

The input/output device 940 provides input/output operations for the system 900. In one implementation, the input/output device 940 can include one or more network interface devices, e.g., an Ethernet card, a serial communication device, e.g., and a RS-232 port, and/or a wireless interface device, e.g., and an 802.11 card. In another implementation, the input/output device can include driver devices configured to receive input data and send output data to other input/output devices, e.g., keyboard, printer and display devices 960. Other implementations, however, can also be used, such as mobile computing devices, mobile communication devices, set-top box television client devices, etc.

Although the above description refers to a content item such as an advertisement, content items such as video and/or audio files, web pages for particular subjects, news articles, etc. can also be used.

Furthermore, the features and methods described can also be used in another form of online advertising such as ad syndication, which allows advertisers to extend their marketing reach by distributing advertisements to additional partners. For example, third party online publishers can place an advertiser's text or image advertisements on web properties with desirable content to drive online customers to the advertiser's website. An example of such a system is AdSense™ offered by Google, Inc. The features and methods described above can be used to allow the display of plusboxes along with the advertisements placed on the publisher's websites.

The apparatus, methods, flow diagrams, and structure block diagrams described in this patent document may be implemented in computer processing systems including program code comprising program instructions that are executable by the computer processing system. Other implementations may also be used. Additionally, the flow diagrams and structure block diagrams described in this patent document, which describe particular methods and/or corresponding acts in support of steps and corresponding functions in support of disclosed structural means, may also be utilized to implement corresponding software structures and algorithms, and equivalents thereof.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A computer-implemented method, comprising:
receiving a query including one or more keywords from a client device;
identifying sponsored content associated with the one or more keywords;
identifying a product or service associated with the sponsored content based on the one or more keywords;
generating display data for displaying the sponsored content at the client device;
generating selection data for displaying information associated with the product or service proximate to the sponsored content at the client device; and
providing the display data and the selection data to the client device.

2. The method of claim 1, wherein the selection data is operable to cause the client device to display a product selection element and to display the product/service information associated with the product or service proximate to the sponsored content in response to a selection of the product selection element.

3. The method of claim 2, wherein the information includes at least one of an image, a description, a price, a brand identification, and a categorization.

4. The method of claim 3, wherein identifying a product or service associated with the sponsored content based on the one or more keywords comprises:
comparing the description to the one or more keywords;
calculating a relevancy measure of the description to the one or more keywords; and
determining whether the product or service is associated with the one or more keywords based on the relevancy measure.

5. A computer-implemented method, comprising:
receiving a first query including one or more keywords;
identifying sponsored content associated with the one or more keywords;
providing display data for displaying the sponsored content to a client device;
providing selection data for generating a product/service information element and for displaying product/service information proximate to the sponsored content to the client device;
in response to receiving data indicating a selection of the product/service information element, issuing a second query including the one or more keywords;
identifying a product or service associated with the sponsored content based on the one or more keywords; and
providing product/service information associated with the product or service to the client device for displaying proximate to the sponsored content.

6. The method of claim 5, wherein the information includes at least one of an image, a description, a price, a brand identification, and a categorization.

7. The method of claim 6, wherein identifying a product or service associated with the sponsored content based on the one or more keywords comprises:
comparing the description to the one or more keywords;
calculating a relevancy measure of the description to the one or more keywords; and
determining whether the product or service is associated with the one or more keywords based on the relevancy measure.

8. A computer-implemented method, comprising:
receiving a first query including one or more keywords;
identifying sponsored content associated with the one or more keywords;
receiving a second query including the one or more keywords;
identifying a product or service associated with the sponsored content based on the one or more keywords;
storing information associated with the product or service in a cache device;
receiving a selection from a display device indicating a request to display the information associated with the product or service; and
providing the information associated with the product or service stored in the cache device to the display device.

9. The method of claim 8, wherein the information includes at least one of an image, a description, a price, a brand identification, and a categorization.

10. The method of claim 8, wherein identifying a product or service associated with the sponsored content based on the one or more keywords comprises:
identifying one or more products or services associated with the sponsored content based on the one or more keywords.

11. The method of claim 9, wherein identifying a product or service associated with the sponsored content based on the one or more keywords comprises:
comparing the description to the one or more keywords;
calculating a relevancy measure of the description to the one or more keywords; and
determining whether the product or service is associated with the one or more keywords based on the relevancy measure.

12. A method, comprising:
issuing a first query including one or more keywords;
receiving and displaying sponsored content associated with the one or more keywords in response to issuing the query;
displaying a product/service information element proximate to the sponsored content; and
in response to receiving a selection of the product/service information element, displaying product/service information associated with the sponsored content in an enlargement area proximate to the sponsored content.

13. The method of claim 12, wherein the product/service information includes at least one of an image, a description, a price, a brand identification, and a categorization.

14. The method of claim 12, wherein displaying a product/service information element proximate to the sponsored content comprises:
displaying the product/service information element immediately below the sponsored content.

15. The method of claim 12, wherein the product/service information element is a plusbox.

16. The method of claim 15, further comprising:
expanding the enlargement area upon selection of the plusbox.

17. The method of claim 15, further comprising:
collapsing the enlargement area upon selection of the plusbox.

18. A system, comprising:
a data store configured to store sponsored content and products or services associated with the sponsored content; and
an advertisement engine configured to receive a query including one or more keywords from a client device, identify the sponsored content from the stored sponsored content, the sponsored content associated with the one or more keywords, identify a product or service from the stored products and services associated with the sponsored content based on the one or more keywords, generate display data for displaying the sponsored content at the client device, generate selection data for displaying information associated with the product or service proximate to the sponsored content at the client device, and provide the display data and the selection data to the client device.

19. The system of claim 18, wherein the selection data is operable to cause the client device to display a product selection element and display the product/service information associated with the product or service proximate to the sponsored content in response to a selection of the product selection element.

20. The system of claim 18, wherein the information includes at least one of an image, a description, a price, a brand identification, and a categorization.

21. The system of claim 20, wherein the advertising engine:
compares the description to the one or more keywords, calculates a relevancy measure of the description to the one or more keywords, and determines whether the product or service is associated with the one or more keywords based on the relevancy measure.
